(19) United States
(12) Patent Application Publication
(10) Pub. No.: US 2006/0107258 A1
(43) Pub. Date: May 18, 2006

(54) Program, program code optimization method, program code compile method, program code, and information processing system

(76) Inventor: Motoyasu Takabatake, Choufu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/268,567

(22) Filed: Nov. 8, 2005

(30) Foreign Application Priority Data
Nov. 10, 2004 (JP) 2004-326878

(51) Int. Cl. G06F 9/45

(52) U.S. Cl. 717/151

(57) ABSTRACT

A program which causes an information processing system storing program code containing a plurality of routines to execute the following steps to perform inter-procedural optimization on part of the program code. The system generates a clone of each routine that is going to be called by another routine from among the routines contained in the program code; replaces each instruction calling an other routine and being contained in one of the routines and the clones forming the program code with an instruction calling the clone of the other routine; and rewrites instructions contained in each of the clones forming part of the program code so as to optimize information processing implemented by a routine or a clone that calls the each of the clones.

### CROSS-REFERENCE TO RELATED APPLICATIONS

The present application claims priority from Japanese Patent Application No. 2004-326878 filed on Nov. 10, 2004, which is herein incorporated by reference.

### BACKGROUND OF THE INVENTION

1. Field of the Invention

The present invention relates to a program, a program code optimization method, a program code compiling method, program code, and an information processing system.

2. Description of the Related Art

In order to cause a computer to execute information processing, program code, a group of instructions to be executed by the computer, must be created. This program code is created as source code using a high-level language such as the C language or FORTRAN. Thereafter, the source code is translated by a compiler into object code executable by a computer. Alternatively, a number of object codes produced by a compiler may be linked together by a linker to produce program code executable by a computer. The computer executable program code produced by the linker may be called executable code, to distinguish from object code produced by a compiler.

When program code is translated by a compiler or a linker, so-called optimization may be performed. The optimization refers to rewriting program code such that the computer executes information processing embodied by the program code more efficiently. For example, in order to reduce the frequency at which the CPU (Central Processing Unit) writes/reads data into/from main memory, the program code is rewritten so as to reduce the occurrences of load instructions and store instructions which cause the CPU to write/read data into/from main memory, and in order to reduce the frequency at which the CPU executes branch instructions, loop unrolling is performed to unroll loops. The optimization of program code enables executing the information processing in a shorter time and reducing memory usage in executing the information processing.

When program code includes a plurality of routines (for example, procedures or functions), the optimization is performed not only on the inside of each of the routines but also on association with other routines. Refer to, for example, Mary W. Hall, Brian R. Murphy, Saman P. Amarasinghe, Shih-Wei Liao, Monica S. Lam, “Interprocedural Analysis for Parallelization”, Proceedings of the 8th International Workshop on Languages and Compilers for Parallel Computing (LCPC95), 1995, and Vugranam C. Sreedhar, Michael Burke, Jong-Deok Choi, “A framework for interprocedural optimization in the presence of dynamic class loading”, Conference on Programming Language Design and Implementation, pp. 196-207, 2000.

For example, the publication by Mary W. Hall et al. discloses technology wherein when optimization over a plurality of routines (hereinafter called “inter-procedural optimization”) is performed statically, the inter-procedural optimization is applied to all procedures (or functions) forming the whole program code (hereinafter, routines such as procedures or functions being also called “procedures”).

The publication by Vugranam C. Sreedhar et al. discloses technology wherein a JIT compiler to dynamically compile program code written in JAVA (registered trademark), in execution, analyzes call-relationships between procedures and performs the inter-procedural optimization, and during the time when the call-relationships continue, same executable code is executed, and when the call-relationships change, the JIT compiler recompiles the program code and performs the inter-procedural optimization again.

The conventional inter-procedural optimization is performed on the whole program code. Hence, when the program code is on a large scale, compiling takes a long time and enormous memory usage.

However, when an attempt is made to perform inter-procedural optimization on only part of the program code (hereinafter called a “sub-program code”), if a procedure contained in the sub-program code on which the inter-procedural optimization is to be performed is going to be called by a procedure contained in a sub-program code on which the inter-procedural optimization is not to be performed, the inter-procedural optimization cannot be performed on the sub-program code. This is because the inter-procedural optimization rewrites the sub-program code.

Moreover, an attempt to perform inter-procedural optimization on only a sub-program code causes call-relationships between procedures to become inaccurate, in which situation it may be inaccurate by which procedure a procedure is called. That is, procedure information of callers becomes inaccurate, and thus, the inter-procedural optimization cannot be applied.

### SUMMARY OF THE INVENTION

The present invention was made in view of the above problem. A main object of the invention is to provide a program, a program code optimization method, a program code compiling method, program code, and an information processing system which enable inter-procedural optimization for sub-program codes.

Inter-procedural optimization for sub-program codes becomes possible, and thus, the compile time and memory usage can be reduced compared with the case of performing inter-procedural optimization on the whole program code.

In order to solve the above problem, according to the present invention there is provided a program which causes an information processing system storing program code containing a plurality of routines to execute the steps of generating a clone of each routine that is going to be called by another routine from among the routines contained in the program code; replacing each instruction calling an other routine and being contained in one of the routines and the clones forming the program code with an instruction calling the clone of the other routine; and rewriting instructions contained in each of the clones forming part of the program code so as to optimize information processing implemented by a routine or a clone that calls the each of the clones.

Inter-procedural optimization for sub-program codes becomes possible, and thus, the compile time and memory usage can be reduced compared with the case of performing inter-procedural optimization on the whole program code.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a block diagram illustrating the configuration of an information processing system according to the present embodiment;

FIG. 2 is a diagram showing a compiler and linker according to the present embodiment;

FIG. 3 is a diagram showing the compiler according to the present embodiment;

FIG. 4 is a diagram showing inter-procedural optimization of program code according to the present embodiment;

FIG. 5 is a diagram showing a call graph according to the present embodiment;

FIG. 6 is a diagram showing a call graph according to the present embodiment;

FIG. 7 is a diagram showing a call graph according to the present embodiment;

FIG. 8 is a diagram showing the linker according to the present embodiment;

FIG. 9 is a flow chart showing the processing of inter-procedural optimization according to the present embodiment;

FIG. 10 is a diagram showing program code according to the present embodiment;

FIG. 11 is a diagram showing a call graph according to the present embodiment;

FIG. 12 is a diagram showing a call graph according to the present embodiment;

FIG. 13 is a diagram showing a linker according to the present embodiment;

FIG. 14 is a flow chart showing the processing of inter-procedural optimization according to the present embodiment;

FIG. 15 is a diagram showing object code according to the present embodiment;

FIG. 16 is a diagram showing a call graph according to the present embodiment;

FIG. 17 is a diagram showing compiler options according to the present embodiment;

FIG. 18 is a flow chart showing the processing of inter-procedural optimization according to the present embodiment;

FIG. 19 is a diagram showing program code according to the present embodiment;

FIG. 20 is a flow chart showing the processing of inter-procedural optimization according to the present embodiment;

FIG. 21 is a diagram showing program code according to the present embodiment;

FIG. 22 is a flow chart showing the processing of inter-procedural optimization according to the present embodiment; and

FIG. 23 is a diagram showing a call graph according to the present embodiment.

### DETAILED DESCRIPTION OF THE INVENTION

At least the following matters will be made clear by the explanation in the present specification and the description of the accompanying drawings.

[Configuration of Information Processing System]

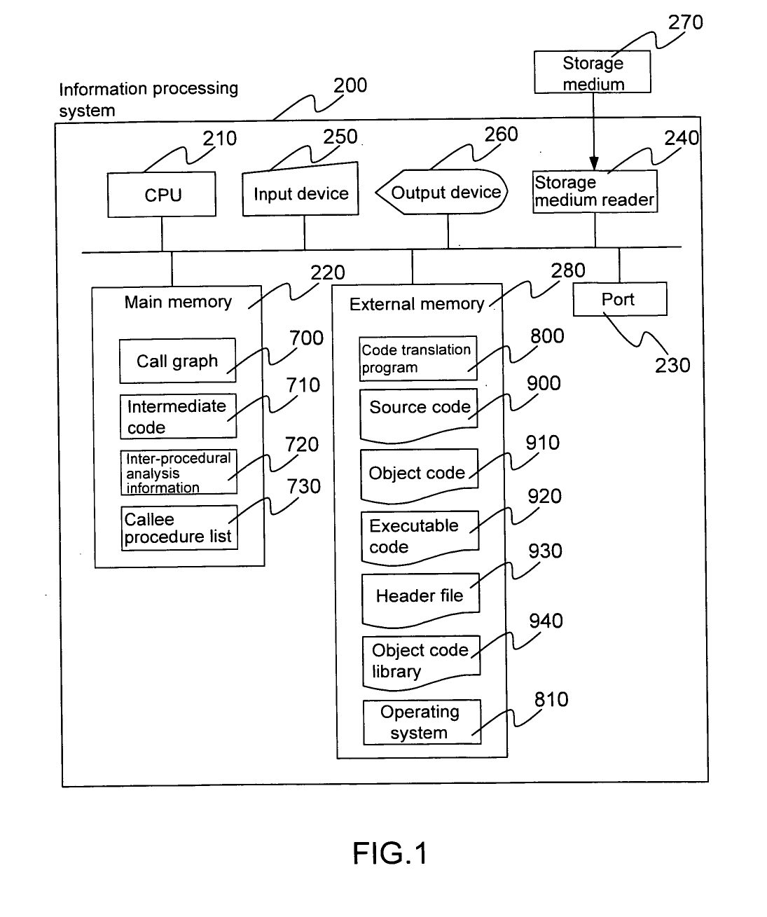

FIG. 1 shows an information processing system 200 according to the present invention. The information processing system 200 comprises a CPU 210, a main memory 220, a port 230, a storage medium reader 240, an input device 250, an output device 260, and an external memory 280.

The CPU 210 controls the information processing system 200 overall, and by executing a code translation program 800 made up of codes stored in the external memory 280 to perform various operations according to the present invention under the control of an operating system 810, various functions of the information processing system 200 of the present invention are realized. For example, the CPU 210 executes the code translation program 800 and the operating system 810 with operating in cooperation with hardware equipment such as the main memory 220, the port 230, the storage medium reader 240, the input device 250, the output device 260, and the external memory 280, thereby realizing a program code store section, a cloned routine generator, a call instruction change section, and an optimizing section.

The main memory 220 can be constituted by, e.g., a semiconductor memory, and is used by the CPU 210 as a work area and stores a call graph 700, intermediate code 710, inter-procedural analysis information 720, and a call procedure list 730, which is described later in detail.

The storage medium reader 240 is a device for reading out programs and data stored in a storage medium 270. The programs and data read out are stored into the main memory 220 and the external memory 280. Hence, the code translation program 800 stored in the storage medium 270 is read out from it, and can be stored in the main memory 220 or the external memory 280.

Flexible disks, magnet tapes, compact disks, and the like can be used as the storage medium 270. The storage medium reader 240 may be embodied as being incorporated in the information processing system 200 or being attached externally.

The external memory 280 may be, for example, a hard disk device or a semiconductor memory, and stores the code translation program 800, the operating system 810, source code 900, an object code 910, executable code 920, a header file 930, and an object code library 940.

The input device 250 is a device used to input data into the information processing system 200 and functions as a user interface. For example, a keyboard, a mouse, and the like can be used as the input device 250.

The output device 260 is a device used to output information to the outside and functions as a user interface. For example, a display, a printer, and the like can be used as the output device 260.

The port 230 is a device for communication, and can communicate with other information processing apparatuses, for example, via a network. In this case, the code translation program 800 can be received from another information processing apparatus via the network and stored into the main memory 220 or the external memory 280.

The source code 900 is program code written in a high-level language such as the C language or FORTRAN. The object code 910 is program code executable by the information processing system 200 and produced from the source code 900 by the code translation program 800, which functions as a compiler. The executable code 920 is program code executable by the information processing system 200 and produced from a plurality of the object codes 910 by the code translation program 800, which functions as a linker.

The object code library 940 is an object code 910 configured to have a number of procedures gathered. Another object code 910 that uses procedures contained in the object code library 940 is linked with the object code library 940 to produce the executable code 920, and thereby the compiling of the procedures contained in the object code library 940 is unwarranted, thus improving efficiency in development of the program code.

The header file 930 is program code having information indicating procedures that are going to be called from the other object code 910 from among the procedures contained in the object code library 940.

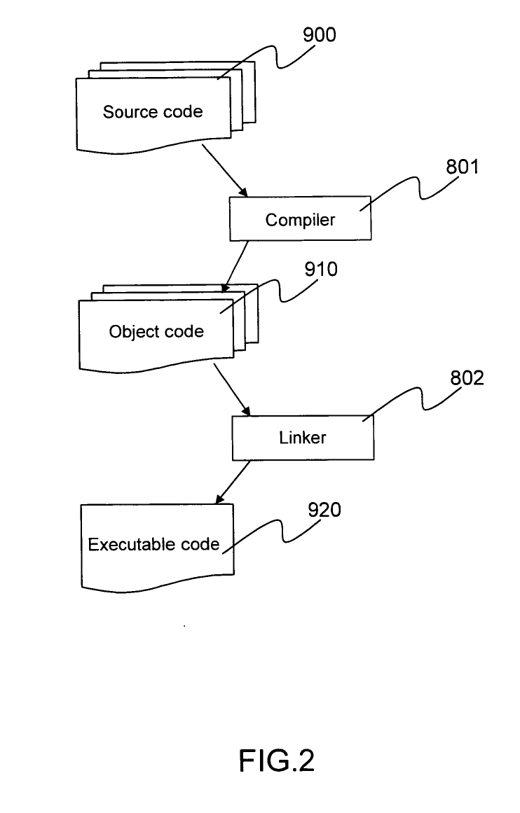

FIG. 2 shows a sequence of compile and link. First, when source codes 900 are input to a compiler 801 (i.e., the code translation program 800), object codes 910 are produced. Then, the object codes 910 are input to a linker 802 (i.e., the code translation program 800), thus producing the executable code 920.

The object code 910 contains various information pieces for inter-procedural optimization such as intermediate code. Hence, the compiler 801 produces the object code 910 containing information for inter-procedural optimization. The compiler 801 can have a plurality of source codes 900 inputted thereto, but when using a tool such as a make command, one source code 900 is input at a time, thus producing one object code 910.

The linker 802 has inputted thereto all object codes 910 to form the program code, and hence, all procedures to form the program code are provided for the linker 802. Inter-procedural optimization has been conventionally performed by the linker 802. In this embodiment, since partial inter-procedural optimization is possible, either of the compiler 801 and the linker 802 can perform inter-procedural optimization.

[Configuration of Compiler and Linker]

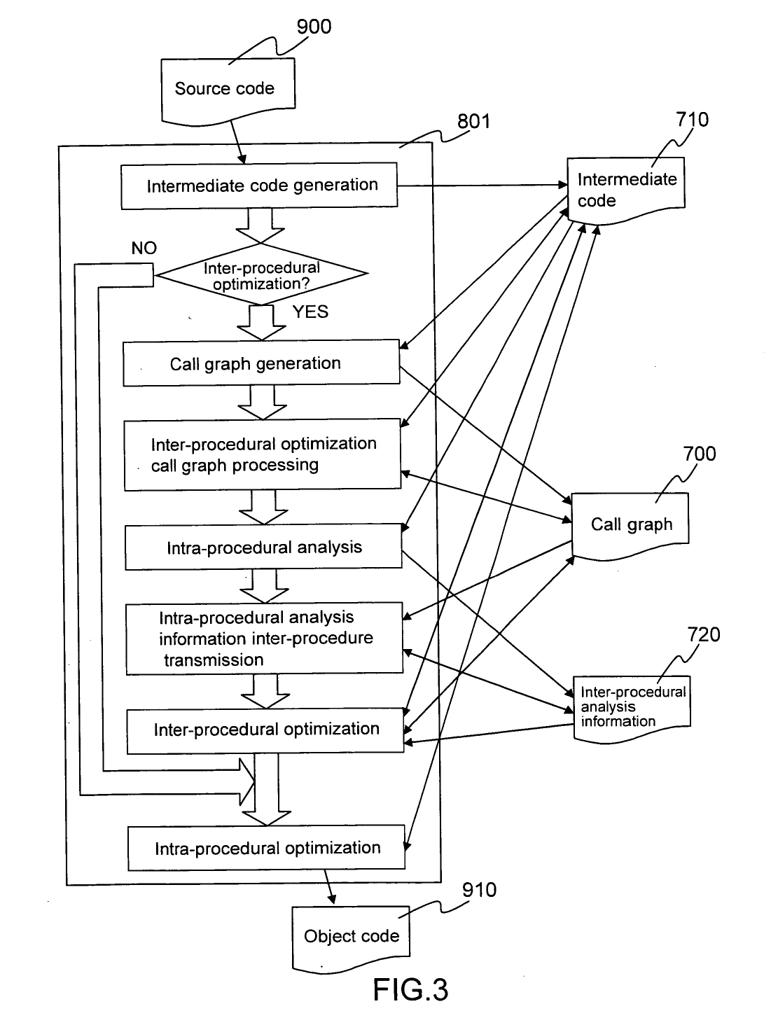

FIG. 3 is a diagram showing the configuration of the compiler 801 to perform inter-procedural optimization.

As shown in FIG. 3, the compiler 801 to perform inter-procedural optimization produces an object code 910 based on a source code 900 inputted. In producing the object code 910, intermediate code 710, a call graph 700, and inter-procedural analysis information 720 are output to the main memory 220 as needed, and using them, processing proceeds.

The compiler 801 comprises an intermediate code generator, a call graph generator, an inter-procedural optimization call graph processing section, an intra-procedural analysis section, an intra-procedural analysis information inter-procedure-transmitting section, an inter-procedural optimizing section, and an intra-procedural optimizing section.

The intermediate code generator has a source code 900 inputted thereto and generates intermediate code 710.

The call graph generator has the intermediate code 710 inputted thereto and generates a call graph 700 indicating call-relationships between procedures. The call graph 700 is a graph where each procedure contained in the program code is represented as a node and the nodes are joined by arrows, which each are directed from a caller node representing a procedure to call an other procedure to a callee node representing the other procedure to be called by the procedure.

The inter-procedural optimization call graph processing section has the intermediate code 710 and the call graph 700 inputted thereto and clones procedures and updates the call graph 700. Here, to clone means to produce a copy of a procedure, which will be described later in detail.

The intra-procedural analysis section has the intermediate code 710 inputted thereto and analyzes information in procedures necessary for the inter-procedural optimization and outputs the inter-procedural analysis information 720. The inter-procedural analysis information 720 is a table storing information necessary for the inter-procedural optimization. The intra-procedural analysis section outputs, for example, the values of arguments for calling another procedure into the inter-procedural analysis information 720.

The intra-procedural analysis information inter-procedure-transmitting section has the call graph 700 and the inter-procedural analysis information 720 inputted thereto and updates the inter-procedural analysis information 720 with tracing edges in the call graph 700. For example, the values of arguments for calling a procedure are stored as the values of parameters for the called procedure into the inter-procedural analysis information 720.

The inter-procedural optimizing section has the inter-procedural analysis information 720 and the call graph 700 inputted thereto and performs inter-procedural optimization and updates the intermediate code 710. That is, instructions contained in the copy of each procedure generated by the cloning are rewritten so as to optimize information processing implemented by a procedure or a copy that calls that copy.

The intra-procedural optimizing section has the inter-procedure optimized intermediate code 710 inputted thereto and performs intra-procedural analysis and intra-procedural optimization, and updates the intermediate code 710, and then outputs an object code 910.

Here, the intermediate code generator, the call graph generator, the intra-procedural analysis section, the intra-procedural analysis information inter-procedure-transmitting section, the inter-procedural optimizing section, and the intra-procedural optimizing section are the same as in the conventional inter-procedural optimization compiler. In the present embodiment, the inter-procedural optimization call graph processing section processes so as to enable inter-procedural analysis on sub-program codes as well.

Note that without performing the inter-procedural optimization, the source code 900 can be compiled, in which case after processing by the intermediate code generator, an object code 910 is generated through processing by the intra-procedural optimizing section. It can be designated whether the inter-procedural optimization is to be performed by the operator of the information processing system 200 when entering a compile command through the input device 250.

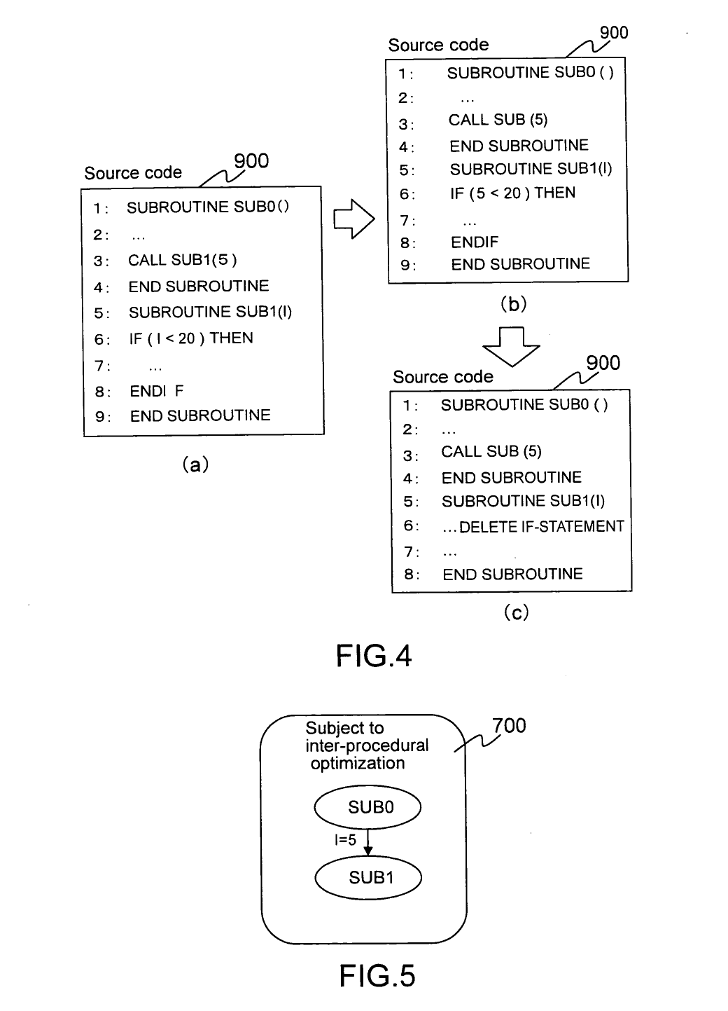

An example of the case of executing the inter-procedural optimization will be described with reference to FIGS. 4 to 7. As an example of the inter-procedural optimization, inter-procedural constant transmission is illustrated.

In the source code 900 denoted by (a) of FIG. 4, a procedure SUB0 calls a procedure SUB1 at the third line, where the argument is 5. The called procedure SUB1 at the fifth line uses I as its parameter. If applying the inter-procedural constant transmission to the source code 900, the SUB1 has the I replaced by the 5 as shown on the sixth line of (b) of FIG. 4. Then, since the conditional expression “5<20” in the IF-statement on the sixth line in (b) of FIG. 4 is always true, this IF-statement is deleted by applying the intra-procedural optimization to the SUB1, thus optimizing the source code 900 to be as shown in (c) of FIG. 4. For this case, the call graph 700 is shown in FIG. 5.

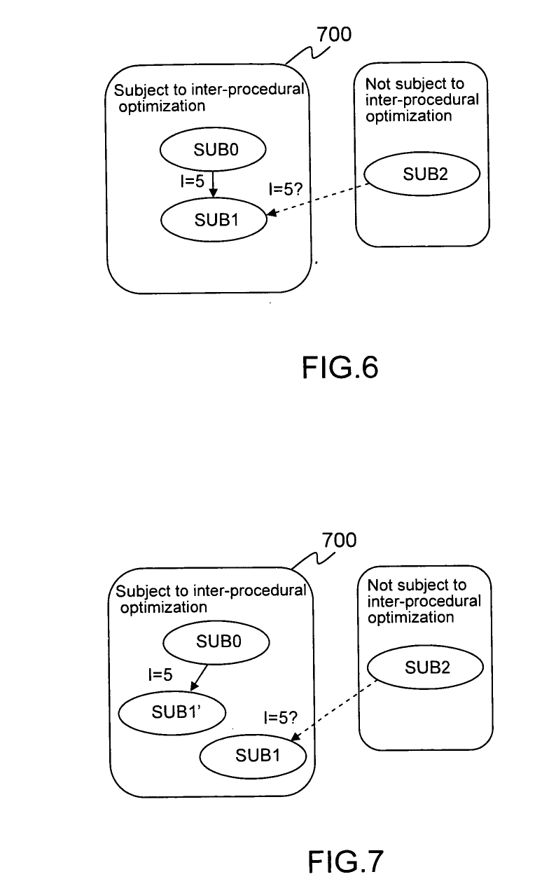

If the procedures SUB0 and SUB1 form the whole source code 900, the above optimization is valid. However, where the procedures SUB0 and SUB1 form a sub-program code and another sub-program code to which the inter-procedural optimization is not applied has a procedure SUB2, the procedure SUB2 may call the procedure SUB1. Furthermore, when the procedure SUB2 calls the procedure SUB1, the I may not be 5. Meanwhile, since the procedure SUB2 is not subject to the inter-procedural optimization, it is unknown whether the procedure SUB2 calls the procedure SUB1. Even if the procedure SUB2 is assumed to call the procedure SUB1, the value of the I cannot be known through analysis. If the inter-procedural optimization is applied over the procedures SUB0 and SUB1 thus optimizing the procedure SUB1 to have the I set to 5, and if the procedure SUB2 calls the procedure SUB1 with a value other than 5 as the I, the program code may operate against the intention of the program code creator, which situation is shown by the call graph 700 of FIG. 6.

As such, when an attempt is made to perform the inter-procedural optimization on a sub-program code, it is unknown whether a procedure not subject to the inter-procedural optimization is going to call a procedure subject to the inter-procedural optimization, and hence, the inter-procedural optimization cannot be achieved.

Accordingly, in the present embodiment, procedure cloning as shown in FIG. 7 is performed. The case is described below where the whole program code is made up of the three procedures SUB0, SUB1, SUB2 and of them the inter-procedural optimization is applied to the procedures SUB0 and SUB1 forming a sub-program code. In the present embodiment, the procedure cloning is performed on the procedure SUB1, thereby producing a procedure SUB1′. Then, the procedure SUB0 is changed to call not the procedure SUB1 but the procedure SUB1′. In this case, it never occurs that the procedure SUB2 calls the procedure SUB1′. That is, since an unknown caller procedure does not exist, it becomes possible to apply the inter-procedural constant transmission with I=5 over the procedures SUB0 and SUB1′. And the procedure SUB2 can call the procedure SUB1 without a need for change.

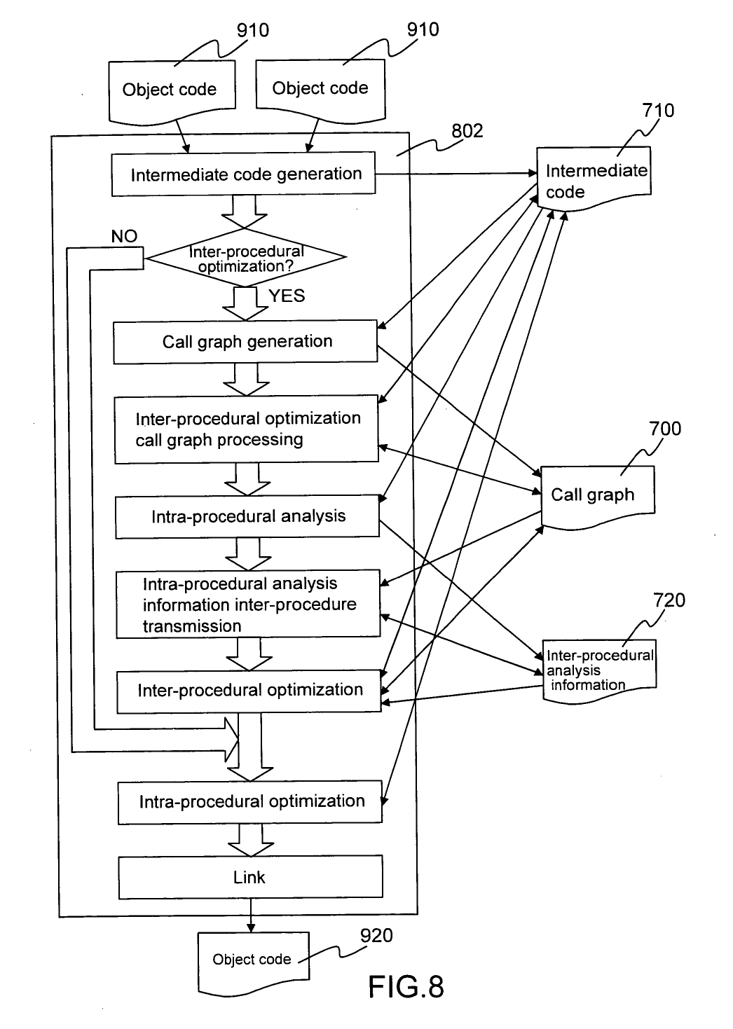

Next, FIG. 8 is a diagram showing the configuration of the linker 802 to perform the inter-procedural optimization.

As shown in FIG. 8, the linker 802 to perform the inter-procedural optimization produces executable code 920 based on object codes 910 inputted. In producing the executable code 920, intermediate code 710, a call graph 700, and inter-procedural analysis information 720 are output to the main memory 220 as needed, and using them, processing proceeds as with the compiler 801.

The linker 802 comprises, as does the compiler 801, an intermediate code generator, a call graph generator, an inter-procedural optimization call graph processing section, an intra-procedural analysis section, an intra-procedural analysis information inter-procedure-transmitting section, an inter-procedural optimizing section, and an intra-procedural optimizing section. The linker 802 further comprises a link section. The link section links the plurality of object codes 910 to produce the executable code 920.

### EXAMPLE 1

In example 1, a method of inter-procedural optimization by the compiler 801 or the linker 802 will be described below. The case of the compiler 801 is taken as an example.

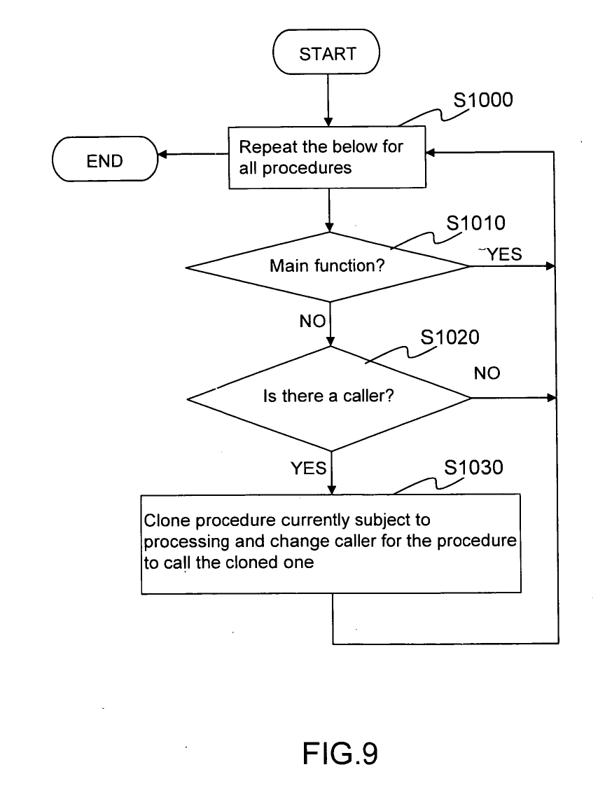

FIG. 9 shows an algorithm of the inter-procedural optimization call graph processing of FIG. 3 according to example 1.

The process starts at START, and S1000 works such that the processes in S1010 and later are repeated for all procedures contained in the call graph 700. Let f be a procedure currently subject to a series of processes starting at S1010. In S1010, it is checked whether the procedure f currently subject to the process is a MAIN function. If being a MAIN function, the procedure f need not be cloned since not being called by another procedure. Hence, having returned to S1000, the next procedure is processed. On the other hand, if not being a MAIN function, the procedure f may need to be cloned, and hence, the process proceeds to S1020. Here, the MAIN function is a function from among the routines forming the program code that is not going to be called by any other function, and may be called a main routine.

In S1020, it is checked whether there is a caller for the procedure f, that is, whether the procedure f is going to be called by another procedure. It can be determined by checking the call graph 700 whether there is a caller. That is, in the call graph 700, if the procedure f has an input edge directed thereto, it means that there is a caller for the procedure f. If there is a caller, the process proceeds to S1030, and if not, returns to S1000.

In S1030, the procedure f is cloned, thereby producing a new procedure f′. And the caller for the procedure f is changed to call the procedure f′. This is done by replacing the instruction calling the procedure f and being contained in the caller for the procedure f with an instruction calling the procedure f′. Then, the process returns to S1000. In S1000, when all procedures have been processed, the process proceeds to END.

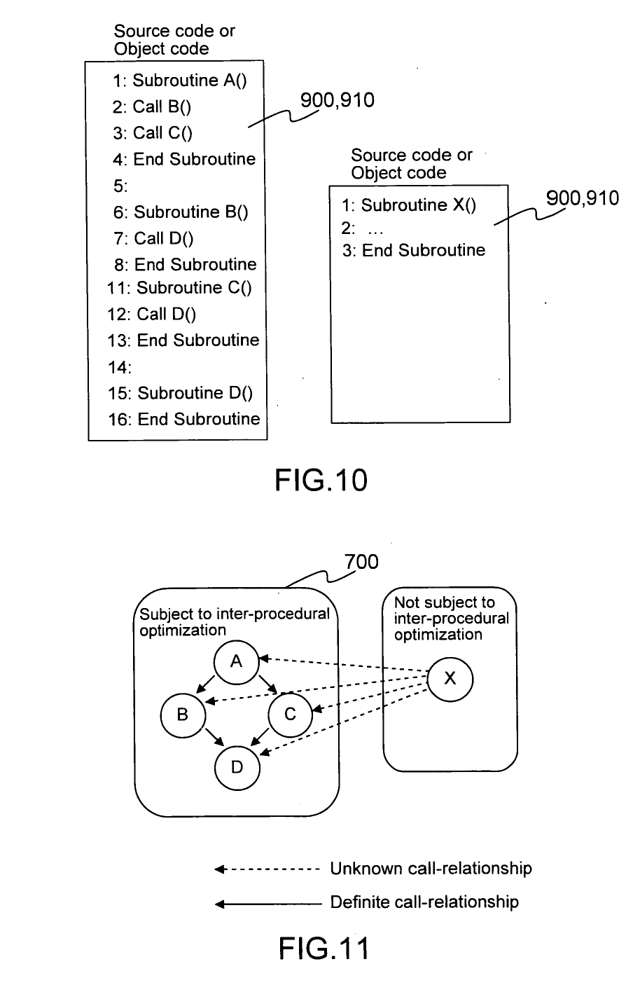

FIG. 10 shows exemplary program code, the whole of which is made up of procedures A, B, C, D, and X. In this example, the inter-procedural optimization is applied to the sub-program code containing the procedures A, B, C, D, while not being applied to the sub-program code containing the procedure X. For the procedures A, B, C, D subject to the inter-procedural optimization, the call graph 700 is as shown in FIG. 11. Since not being subject to the inter-procedural optimization, the procedure X is not included in the call graph 700.

A specific description will be made below of the case where the algorithm of FIG. 9 is applied to the program code of FIG. 10.

First, in S1000 of FIG. 9, the procedure A is selected to be processed. In S1010, since the procedure A is not a MAIN function, S1020 is taken. Upon the test in S1020, since there is no caller for the procedure A, the process returns to S1000. For the procedure A, the process ends without making any change.

Next, the procedure B is selected to be processed. In S1010, since the procedure B is not a MAIN function, S1020 is taken. In S1020, since the procedure A is a caller for the procedure B, S1030 is taken. In S1030, the cloning is applied to the procedure B thereby producing a new procedure B′. Then, the procedure A is changed to call the procedure B′.

The procedures C, D are processed in the same way as the procedure B (S1000 to S1030), thereby producing procedures C′, D′ respectively.

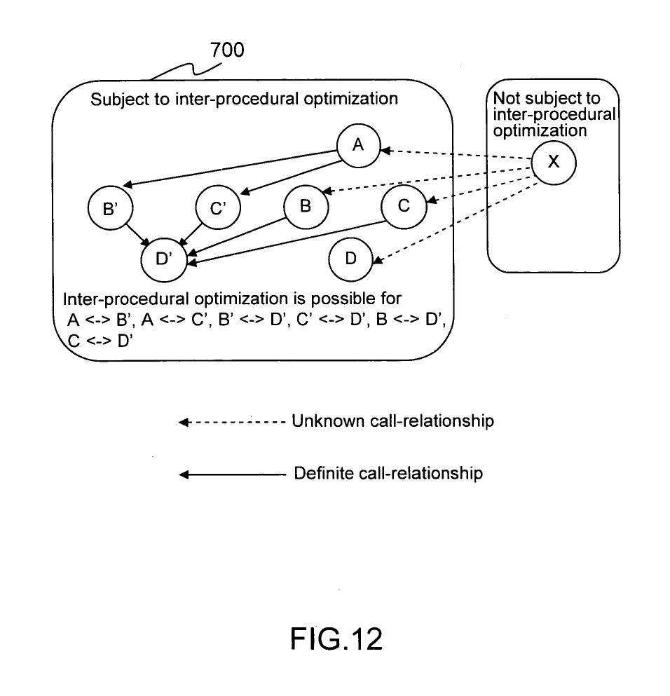

As a result, the call graph 700 has been changed as shown in FIG. 12. The procedures B′, C′, D′ are procedures generated by the cloning. It is unknown whether the procedures B, C, D are called by the procedure X, and hence, inter-procedural optimization cannot be performed over them and the procedure X as a caller. However, because for the procedures B′, C′, D′, there is no unknown caller, inter-procedural optimization can be performed on them. Specifically, inter-procedural optimization can be performed over the procedures A and B′, A and C′, B′ and D′, C′ and D′, B and D′, and C and D′ each.

### EXAMPLE 2

Next, example 2 will be described. In example 2, from among the procedures contained in a first program code subject to inter-procedural optimization and to be called by other procedures, the cloning is performed on procedures to be also called by a procedure contained in a second program code not subject to inter-procedural optimization.

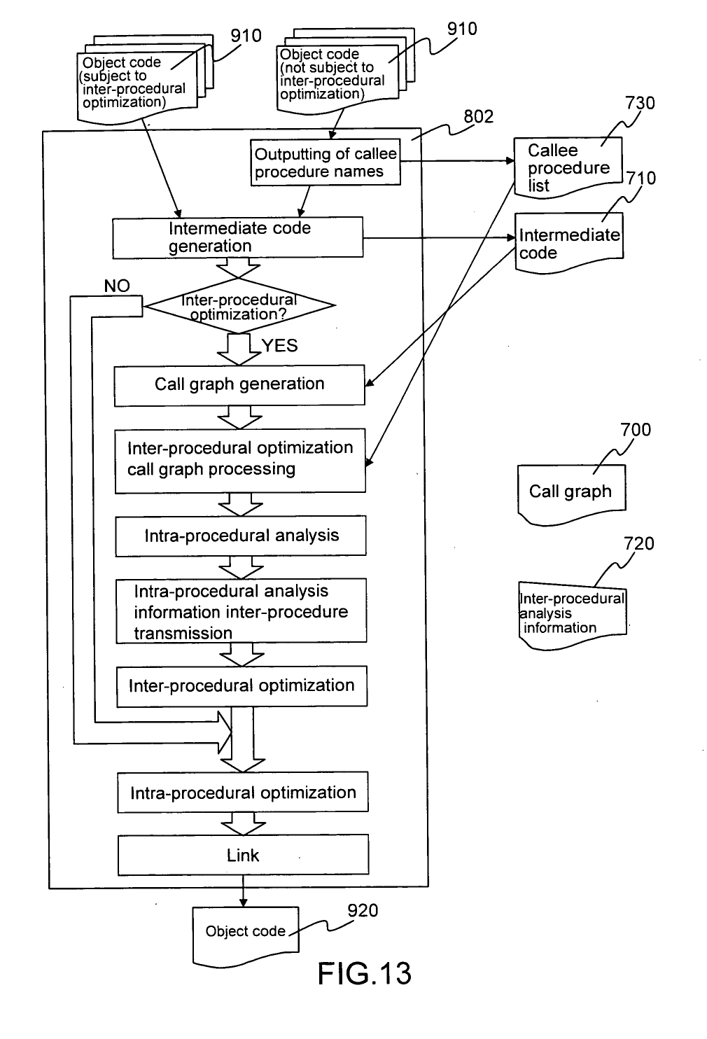

FIG. 13 shows an example of a method of inter-procedural optimization of a sub-program code when linking. The linker 802 of FIG. 8 is expanded as shown in FIG. 13 for inter-procedural optimization.

The linker 802 has inputted thereto an object code 910 subject to inter-procedural optimization and an object code 910 not subject to inter-procedural optimization. The object codes 910 are distinguished according to whether it has inter-procedural optimization information or not.

For the object code 910 not subject to inter-procedural optimization, the linker 802 checks if in the object code 910 there is a reference (procedure call instruction) to a procedure not defined in the object code 910 and outputs the names of such procedures to a callee procedure list 730. That is, the linker 802 outputs into the procedure list 730 information (such as procedure names) designating other procedures than the procedures forming the object code 910 and being contained in ones of the instructions contained in the procedures forming the object code 910, the ones calling the other procedures than the procedures forming the object code 910. This process is performed by a callee procedure name output processor.

The inter-procedural optimization call graph processing section clones ones of the procedures contained in the object code 910 subject to inter-procedural optimization, the ones designated by the information listed in the callee procedure list 730.

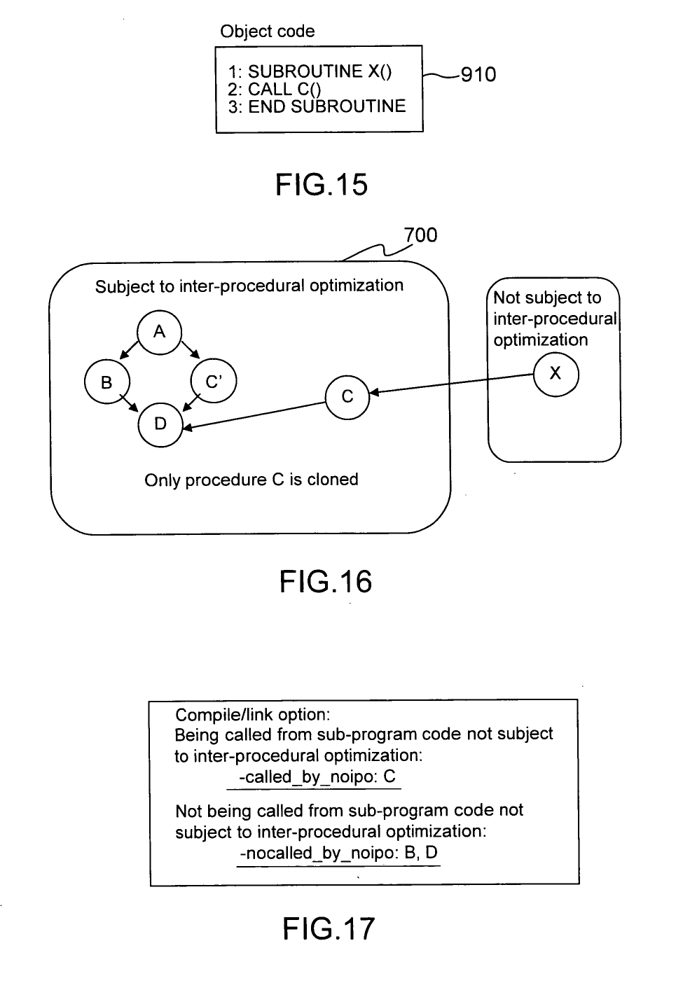

A description will be made below of the case where using the linker 802 of FIG. 13, inter-procedural optimization is performed on the program code of FIG. 10. Here, it is assumed that the procedure X calls the procedure C in the program code of FIG. 10. FIG. 15 shows program code in this case.

The callee procedure name output processor can detect undefined procedures in the object code 910 not subject to inter-procedural optimization by using, e.g., an nm command of UNIX (registered trademark), and then, outputs the names of such procedures to the callee procedure list 730. Since the procedure X calls the procedure C in the object code 910 of FIG. 15, there is a reference to the procedure C, but because the definition of the procedure C is not present, the undefined procedure C is detected and the procedure name “C” is output into the callee procedure list 730.

The inter-procedural optimization call graph processing section clones the procedure using information of the call graph 700 and of the callee procedure list 730.

Finally, the object codes 910 are linked by the linker, thereby outputting executable code 920.

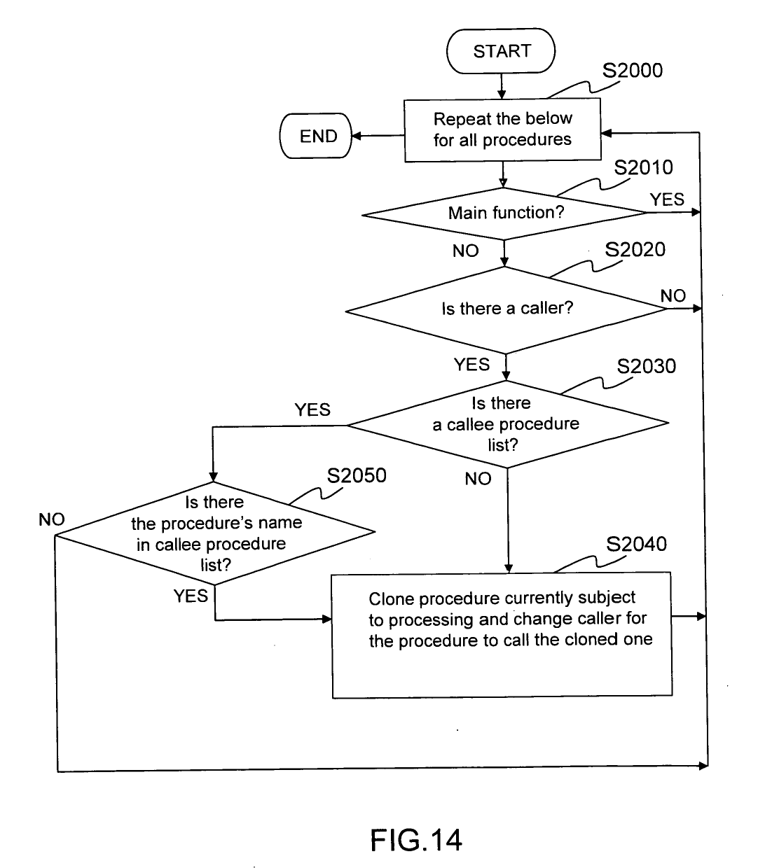

FIG. 14 shows an algorithm of a method of partial inter-procedural optimization when linking.

S2000 works such that the processes in S2010 and later are repeated for all procedures contained in the call graph 700. Let f be a procedure currently subject to a series of processes starting at S2010.

In S2010, it is checked whether the procedure f currently subject to the process is a MAIN function. If being a MAIN function, the process returns to S2000, and if not being a MAIN function, the process proceeds to S2020.

In S2020, it is checked whether there is a caller for the procedure f in the program code subject to inter-procedural optimization, and if not, the process returns to S2000 and if any, proceeds to S2030.

In S2030, it is checked whether the callee procedure list 730 shown in FIG. 13 exists, and if present, the process proceeds to S2050 and if not, to S2040.

In S2050, it is checked whether there is the procedure name of the procedure f in the callee procedure list 730, and if present, the process proceeds to S2040 and if not, returns to S2000.

In S2040, the procedure f is cloned, thereby producing a new procedure f′. And the caller for the procedure f is changed to call the procedure f′. This is done by replacing the instruction calling the procedure f and being contained in the caller for the procedure f with an instruction calling the procedure f′. Then, the process returns to S2000. In S2000, when all procedures have been processed, the process proceeds to END.

In S2030, if no callee procedure list 730, the process proceeds to S2040. This is because with no callee procedure list 730 it cannot be determined whether the procedure is called from the program code not subject to inter-procedural optimization. Hence, the process is configured to proceed to S2040, where the procedure is cloned.

A description will be made below of the case where the algorithm of FIG. 14 is applied to the program code of FIGS. 10, 15.

First, in S2000 of FIG. 14, the procedure A is selected to be processed. In S2010, since the procedure A is not a MAIN function, S2020 is taken. Upon the test in S2020, since there is no caller for the procedure A, the process returns to S2000. For the procedure A, the process ends without making any change.

For the procedure B, in S2010 the procedure B is not a MAIN function, in S2020 the procedure A is a caller, and in S2030 the callee procedure list 730 exists, hence taking S2050. In S2050, since the procedure B is not in the callee procedure list 730, the process returns to S2000.

For the procedure C, in S2010 the procedure C is not a MAIN function, in S2020 the procedure A is a caller, and in S2030 the callee procedure list 730 exists, hence taking S2050. In S2050, since the procedure name “C” is in the callee procedure list 730, the process proceeds to S2040, where the procedure is cloned.

For the procedure D, in S2010 the procedure D is not a MAIN function, in S2020 the procedures B, C are callers, and in S2030 the callee procedure list 730 exists, hence taking S2050. In S2050, since the procedure D is not in the callee procedure list 730, the process returns to S2000.

As a result, the call graph 700 has been changed as shown in FIG. 16. Since not being called from the program code not subject to inter-procedural optimization, the procedures B, D have no unknown caller, and hence, the procedure cloning is not applied thereto. Since the procedure C is going to be called from the program code not subject to inter-procedural optimization, the procedure cloning is applied thereto. As such, by examining callers, the cloning of the procedures B, D is not carried out compared with example 1, thus preventing unnecessary cloning.

### EXAMPLE 3

Next, the case will be described where when compiling or linking, inter-procedural optimization is performed on a sub-program code using an option input by an operator.

FIG. 17 shows an example of an option of being called from the sub-program code not subject to inter-procedural optimization (information designating a to-be-cloned procedure of the procedures forming program code) and an option of not being called from the sub-program code not subject to inter-procedural optimization (information designating a not-to-be-cloned procedure of the procedures forming program code).

In FIG. 17, the option of being called from the sub-program code not subject to inter-procedural optimization designates the procedure C as a procedure that is going to be called from the sub-program code not subject to inter-procedural optimization. In FIG. 17, the option of not being called from the sub-program code not subject to inter-procedural optimization designates the procedures B, D as procedures that are not going to be called from the sub-program code not subject to inter-procedural optimization.

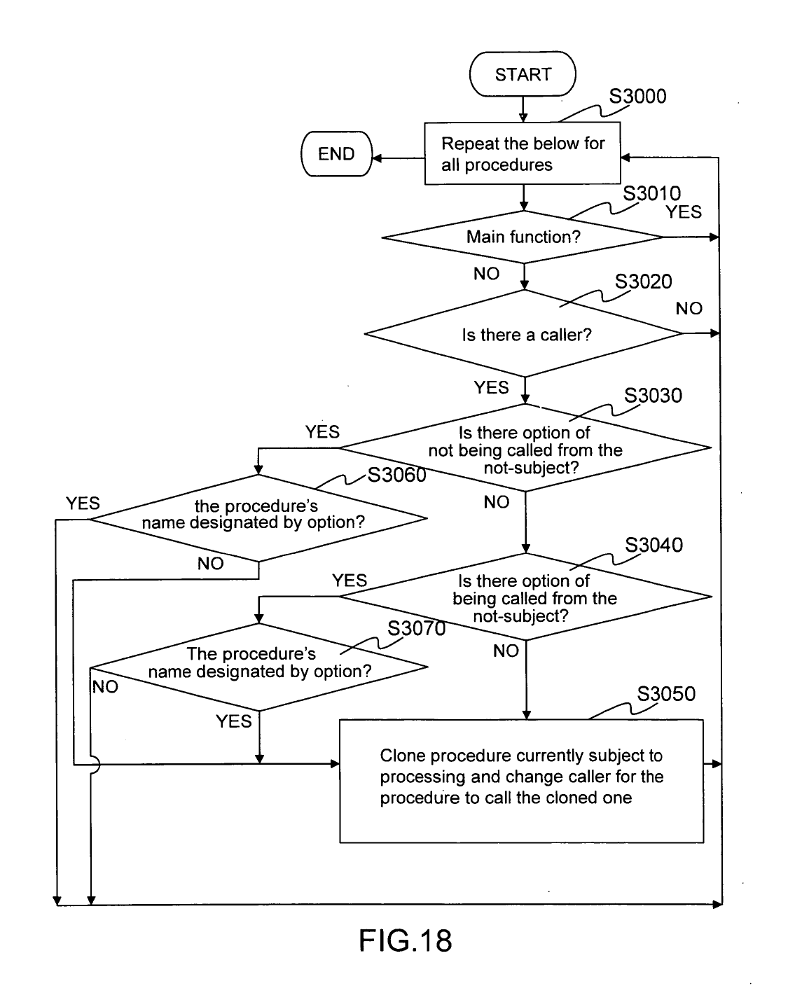

FIG. 18 shows an algorithm for the case where inter-procedural optimization is performed on a sub-program code using these options.

S3000 works such that the processes in S3010 and later are repeated for all procedures contained in the call graph 700. Let f be a procedure currently subject to a series of processes starting at S3010.

In S3010, it is checked whether the procedure f currently subject to the process is a MAIN function. If being a MAIN function, the process returns to S3000, and if not being a MAIN function, the process proceeds to S3020.

In S3020, it is checked whether there is a caller function calling the procedure f in the procedures contained in the sub-program code subject to inter-procedural optimization, and if not, the process returns to S3000 and if any, proceeds to S3030.

In S3030, it is checked whether there is the option of not being called from the sub-program code not subject to inter-procedural optimization, and if present, the process proceeds to S3060 and if not, to S3040.

In S3060, it is checked whether the procedure f is designated by the option of not being called from the sub-program code not subject to inter-procedural optimization, and if designated, the process returns to S3000 and if not, proceeds to S3050.

In S3040, it is checked whether there is the option of being called from the sub-program code not subject to inter-procedural optimization, and if present, the process proceeds to S3070 and if not, to S3050.

In S3070, it is checked whether the procedure f is designated by the option of being called from the sub-program code not subject to inter-procedural optimization, and if designated, the process proceeds to S3050 and if not, returns to S3000.

In S3050, the procedure f is cloned, thereby producing a new procedure f′. And the caller for the procedure f is changed to call the procedure f′. This is done by replacing the instruction calling the procedure f and being contained in the caller for the procedure f with an instruction calling the procedure f′. Then, the process returns to S3000. In S3000, when all procedures have been processed, the process proceeds to END.

If the answer is NO in both S3030 and S3040, that is, if no option has been entered, then the process proceeds to S3050. This is because without an option entered it cannot be determined whether the procedure is going to be called from the sub-program code not subject to inter-procedural optimization. Hence, the process proceeds to S3050, where the procedure is cloned.

A description will be made below of the case where the algorithm of FIG. 18 is applied to the program code of FIGS. 10, 15 with the compile option “-called_by_noipo: C” (option of being called from the sub-program code not subject to inter-procedural optimization) chosen.

First, in S3000 of FIG. 18, the procedure A is selected to be processed. In S3010, since the procedure A is not a MAIN function, S3020 is taken. Upon the test in S3020, since there is no caller for the procedure A, the process returns to S3000. For the procedure A, the process ends without making any change.

For the procedure B, in S3010 the procedure B is not a MAIN function, in S3020 the procedure A is a caller, and in S3030 the option of not being called from the sub-program code not subject to inter-procedural optimization has not been chosen, hence taking S3040. In S3040, since the option of being called from the sub-program code not subject to inter-procedural optimization has been chosen, S3070 is taken. In S3070, since the procedure B is not designated in the option of being called from the sub-program code not subject to inter-procedural optimization, the process returns to S3000.

For the procedure C, in S3010 the procedure C is not a MAIN function, in S3020 the procedure A is a caller, and in S3030 the option of not being called from the sub-program code not subject to inter-procedural optimization has not been chosen, hence taking S3040. In S3040, since the option of being called from the sub-program code not subject to inter-procedural optimization has been chosen, S3070 is taken. In S3070, since the procedure C is designated in the option of being called from the sub-program code not subject to inter-procedural optimization, the process proceeds to S3050, where the cloning and the like are performed.

For the procedure D, in S3010 the procedure D is not a MAIN function, in S3020 the procedures B, C are callers, and in S3030 the option of not being called from the sub-program code not subject to inter-procedural optimization has not been chosen, hence taking S3040. In S3040, since the option of being called from the sub-program code not subject to inter-procedural optimization has been chosen, S3070 is taken. In S3070, since the procedure D is not designated in the option of being called from the sub-program code not subject to inter-procedural optimization, the process returns to S3000.

As a result, the call graph 700 has been changed as shown in FIG. 16. Since not being called from the sub-program code not subject to inter-procedural optimization, the procedures B, D have no unknown caller, and hence, the procedure cloning is not applied thereto. Since the procedure C is going to be called from the sub-program code not subject to inter-procedural optimization, the procedure cloning is applied thereto. As such, by examining callers, the cloning of the procedures B, D is not carried out compared with example 1, thus preventing unnecessary cloning.

### EXAMPLE 4

Next, the case will be described where when compiling or linking, inter-procedural optimization is performed on a sub-program code with a compiler instruction statement written in the source code 900.

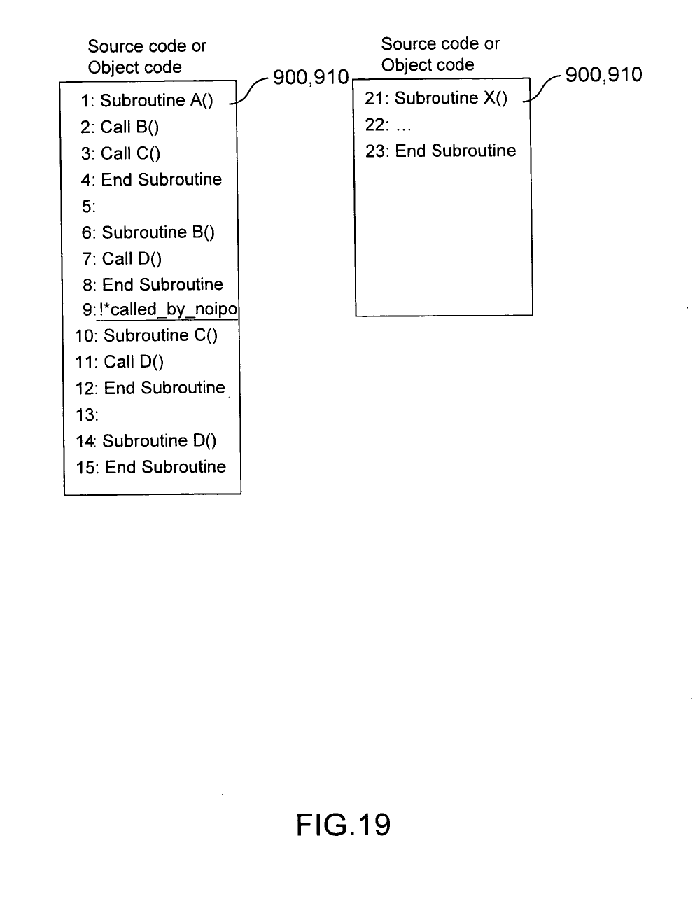

FIG. 19 shows an example of indicating that the procedure is going to be called from a procedure contained in the sub-program code not subject to inter-procedural optimization, with a compiler instruction statement written in the source code 900. The compiler instruction statement is “!$called_{—by}_noipo” on the ninth line of FIG. 19. With this compiler instruction statement, the compiler 801 determines that the procedure C defined in lines 10 to 12 is going to be called from a procedure contained in the sub-program code not subject to inter-procedural optimization.

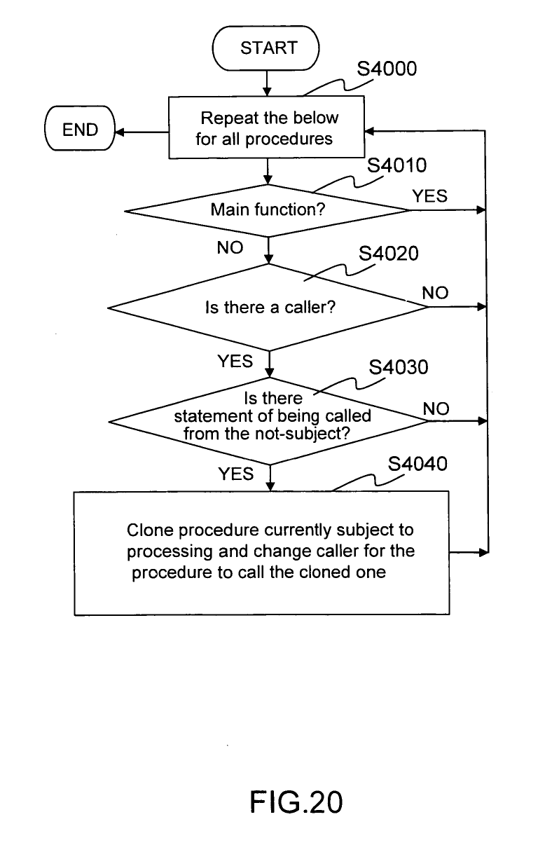

FIG. 20 shows an algorithm for the case where inter-procedural optimization is performed on a sub-program code with the compiler instruction statement.

First, S4000 works such that the processes in S4010 and later are repeated for all procedures contained in the call graph 700. Let f be a procedure currently subject to a series of processes starting at S4010.

In S4010, it is checked whether the procedure f currently subject to the process is a MAIN function. If being a MAIN function, the process returns to S4000, and if not being a MAIN function, the process proceeds to S4020.

In S4020, it is checked whether there is a caller function calling the procedure f in the procedures contained in the sub-program code subject to inter-procedural optimization, and if not, the process returns to S4000 and if any, proceeds to S4030.

In S4030, it is checked whether there is the compiler instruction statement that indicates being called from the sub-program code not subject to inter-procedural optimization, and if present, the process proceeds to S4040 and if not, returns to S4000.

In S4040, the procedure f is cloned, thereby producing a new procedure f′. And the caller for the procedure f is changed to call the procedure f′. This is done by replacing the instruction calling the procedure f and being contained in the caller for the procedure f with an instruction calling the procedure f′. Then, the process returns to S4000. In S4000, when all procedures have been processed, the process proceeds to END.

A description will be made below of the case where the algorithm of FIG. 20 is applied to the program code of FIG. 19.

First, in S4000 of FIG. 20, the procedure A is selected to be processed. In S4010, since the procedure A is not a MAIN function, S4020 is taken. Upon the test in S4020, since there is no caller for the procedure A, the process returns to S4000. For the procedure A, the process ends without making any change.

For the procedure B, in S4010 the procedure B is not a MAIN function, in S4020 the procedure A is a caller, and in S4030, without the compiler instruction statement it is recognized that the procedure B is not going to be called from the sub-program code not subject to inter-procedural optimization, hence returning to S4000.

For the procedure C, in S4010 the procedure C is not a MAIN function, in S4020 the procedure A is a caller, and in S4030, with the compiler instruction statement it is recognized that the procedure C is going to be called from the sub-program code not subject to inter-procedural optimization, hence taking S4040. In S4040, the cloning and the like are performed.

For the procedure D, in S4010 the procedure D is not a MAIN function, in S4020 the procedures B, C are callers, and in S4030, without the compiler instruction statement it is recognized that the procedure D is not going to be called from the sub-program code not subject to inter-procedural optimization, hence returning to S4000.

As a result, the call graph 700 has been changed as shown in FIG. 16, which shows the inter-procedural optimization being the same as in example 2. That is, since not being called from the sub-program code not subject to inter-procedural optimization, the procedures B, D have no unknown caller, and hence, the procedure cloning is not applied thereto. Since the procedure C is going to be called from the sub-program code not subject to inter-procedural optimization, the procedure cloning is applied thereto. As such, by examining callers, the cloning of the procedures B, D is not carried out compared with example 1, thus preventing unnecessary cloning.

### EXAMPLE 5

Next, an example of applying inter-procedural optimization when compiling a library (object code library 940, i.e., first program code), that is, an example of applying inter-procedural optimization to the object code library 940 will be described below.

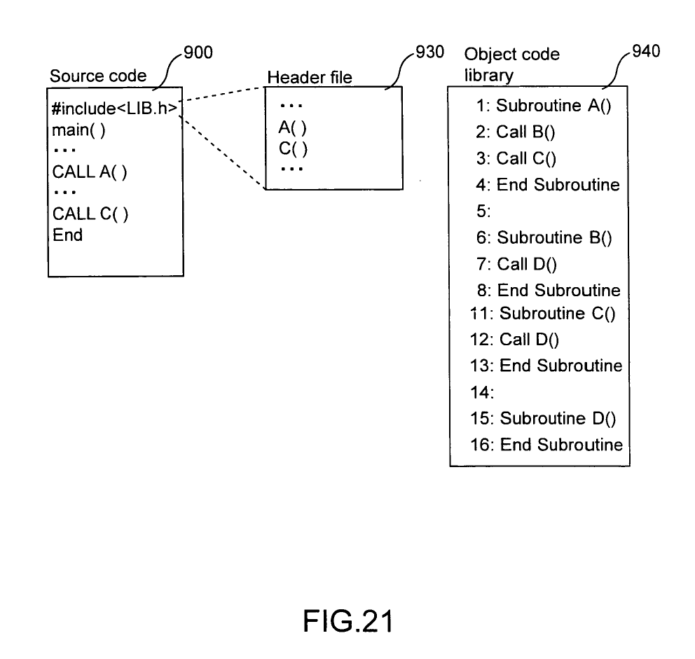

Suppose that in FIG. 10 the program code containing the procedures A, B, C, D is program code (first program code) constituting the library 940, that the program code containing the procedure X is program code (second program code) using the library 940, and that the procedure X calls the procedures A, C, which is shown in FIG. 21.

When using the library 940, a header file 930 is usually included in the program code that uses the library 940. The header file 930 contains information (such as procedure names) indicating procedures that are going to be called from procedures of the program code using the library 940, from among the procedures forming the library 940. Hence, if a procedure contained in the program code constituting the library 940 is not listed in the header file 930, it is determined that this procedure is not going to be called from the program code not subject to inter-procedural optimization. On the other hand, if a procedure contained in the program code constituting the library 940 is listed in the header file 930, it is determined that this procedure is going to be called from the program code not subject to inter-procedural optimization.

Here, suppose that the procedures A, C are declared in the header file as shown in FIG. 21.

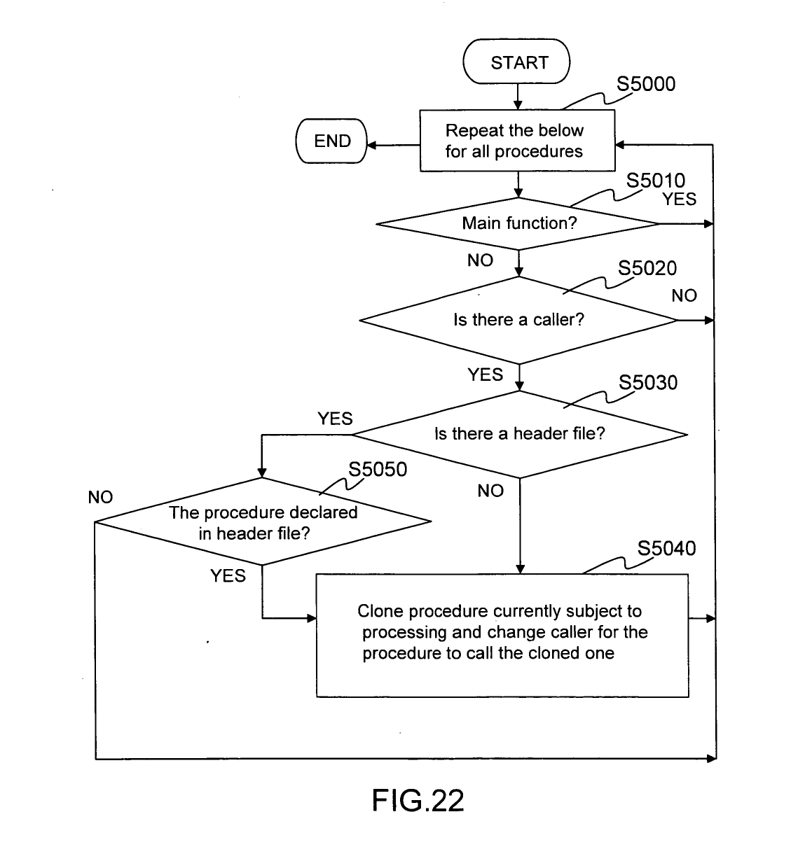

FIG. 22 shows an algorithm for the case where inter-procedural optimization is performed on the library 940.

First, S5000 works such that the processes in S5010 and later are repeated for all procedures contained in the call graph 700. Let f be a procedure currently subject to a series of processes starting at S5010.

In S5010, it is checked whether the procedure f currently subject to the process is a MAIN function. If being a MAIN function, the process returns to S5000, and if not being a MAIN function, proceeds to S5020.

In S5020, it is checked whether there is a caller function calling the procedure f in the procedures contained in the program code subject to inter-procedural optimization, and if not, the process returns to S5000 and if any, proceeds to S5030.

In S5030, it is checked whether there is the header file 930, and if present, the process proceeds to S5050 and if not, to S5040.

In S5050, it is checked whether the procedure f is declared in the header file 930, and if declared, the process proceeds to S5040 and if not, returns to S5000.

In S5040, the procedure f is cloned, thereby producing a new procedure f′. And the caller for the procedure f is changed to call the procedure f′. This is done by replacing the instruction calling the procedure f and being contained in the caller for the procedure f with an instruction calling the procedure f′. Then, the process returns to S5000. In S5000, when all procedures have been processed, the process proceeds to END.

In S5030, if no header file 930 exists, the process proceeds to S5040. This is because with no header file 930 it cannot be determined whether the procedure is called from the program code not subject to inter-procedural optimization. Hence, the process is configured to proceed to S5040, where the procedure is cloned.

An example of applying the algorithm of FIG. 22 will be described below.

First, in S5000 of FIG. 22, the procedure A is selected to be processed. In S5010, since the procedure A is not a MAIN function, S5020 is taken. Upon the test in S5020, since there is no caller for the procedure A, the process returns to S5000. For the procedure A, the process ends without making any change.

For the procedure B, in S5010 the procedure B is not a MAIN function, S5020 is taken. In S5020 the procedure A is a caller, S5030 is taken. In S5030, since there is the header file 930, S5050 is taken. In S5050, since the procedure B is not declared in the header file 930, the process returns to S5000.

For the procedure C, in S5010 the procedure C is not a MAIN function, S5020 is taken. In S5020 the procedure A is a caller, S5030 is taken. In S5030, since there is the header file 930, S5050 is taken. In S5050, since the procedure C is declared in the header file 930, the process proceeds to S5040, where the cloning and the like are performed.

For the procedure D, in S5010 the procedure D is not a MAIN function, S5020 is taken. In S5020 the procedures B, C are callers, S5030 is taken. In S5030, since there is the header file 930, S5050 is taken. In S5050, since the procedure D is not declared in the header file 930, the process returns to S5000.

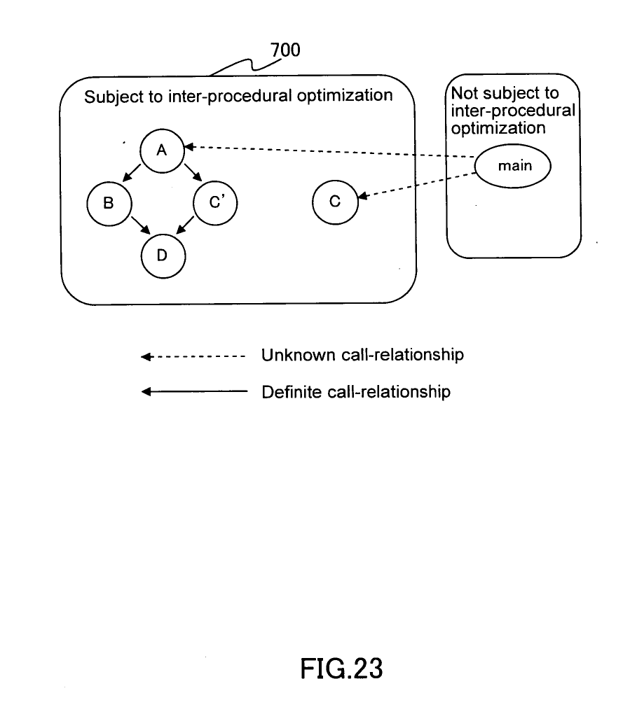

As a result, the call graph 700 has been changed as shown in FIG. 23, which shows the inter-procedural optimization being the same as in example 2. That is, since not being called from the program code not subject to inter-procedural optimization, the procedures B, D have no unknown caller, and hence, the procedure cloning is not applied thereto. Since the procedure C is going to be called from the program code not subject to inter-procedural optimization, the procedure cloning is applied thereto. As such, by examining callers, the cloning of the procedures B, D is not carried out compared with example 1, thus preventing unnecessary cloning.

According to the present embodiment described above, inter-procedural optimization can be performed on sub-program codes. Thus, even if the computer that performs compiling has fewer resources, inter-procedural optimization can be performed.

Furthermore, inter-procedural optimization can be performed on only program code of libraries. Thus, without modifying program code that uses the libraries, the library program code can be optimized. Moreover, where only object code is provided without source code, inter-procedural optimization can be performed over procedures of other source code that is used by the object code.

As described in examples 2 to 5, by designating whether there is a caller for procedures subject to inter-procedural optimization or by examining callers, unnecessary procedure cloning can be prevented.

As described, for example, in example 2, in the case where inter-procedural optimization is performed in linking, if object code subject to inter-procedural optimization and object code not subject to inter-procedural optimization are mixed together, by examining reference information of the procedures in the object code not subject to inter-procedural optimization, it is examined whether an unknown call-relationship exists. That is, by examining whether a reference to a procedure in the object code subject to inter-procedural optimization exists in the object code not subject to inter-procedural optimization, it is examined whether an unknown call-relationship exists. By this means, the number of procedures having the cloning applied thereto can be reduced.

As described in examples 3 and 4, by indicating procedures not having an unknown call-relationship with the compiler instruction statement and compiler option in the source program code, the number of procedures having the cloning applied thereto can be reduced.

As described in example 5, if inter-procedural optimization is performed on a library, by examining the procedure declaration in the header file of the library, it is examined whether a call from program code using the library exists and thus whether an unknown call-relationship exists. Also by this means, the number of procedures having the cloning applied thereto can be reduced.

Although the preferred embodiment of the present invention has been described, the above embodiment is provided to facilitate the understanding of the present invention and not intended to limit the present invention. It should be understood that various changes and alterations can be made therein without departing from spirit and scope of the invention and that the present invention includes its equivalents.

What is claimed is:

1. A program which causes an information processing system storing program code containing a plurality of routines to execute the steps of:
generating a clone of each routine that is going to be called by another routine from among the routines contained in the program code;
replacing each instruction calling an other routine and being contained in one of the routines and the clones forming the program code with an instruction calling the clone of the other routine; and
rewriting instructions contained in each of the clones forming part of the program code so as to optimize information processing implemented by a routine or a clone that calls the each of the clones.

2. The program according to claim 1, which causes the information processing system to execute further the step of:
receiving input of information designating routines to be cloned of the routines contained in the program code from a user interface,
wherein in said step of generating a clone, a clone is generated for each routine designated by the information, and
wherein in said step of replacing, if a clone of the other routine has been generated, the each instruction calling the other routine is replaced with an instruction calling the clone of the other routine.

3. The program according to claim 1, which causes the information processing system to execute further the step of:
receiving input of information designating routines not to be cloned of the routines contained in the program code from a user interface,
wherein in said step of generating a clone, a clone is generated for each routine not designated by the information, and
wherein in said step of replacing, if a clone of the other routine has been generated, the each instruction calling the other routine is replaced with an instruction calling the clone of the other routine.

4. The program according to claim 1, wherein information designating routines to be cloned is contained in the program code,
wherein in said step of generating a clone, a clone is generated for each routine designated by the information, and
wherein in said step of replacing, if a clone of the other routine has been generated, the each instruction calling the other routine is replaced with an instruction calling the clone of the other routine.

5. A program which causes an information processing system storing first program code and second program code each containing a plurality of routines to execute the steps of:
reading out and storing information designating a routine not forming part of the second program code and being contained in each of ones of the instructions contained in the routines contained in the second program code, the each of ones calling the routine not forming part of the second program code;
generating a clone of each routine designated by the information from among the routines contained in the first program code;
replacing each instruction that calls an other routine of which a clone has been generated, from among instructions calling another routine and being contained in the routines and the clones forming the first program code, with an instruction calling the clone of the other routine; and
rewriting instructions contained in each of the clones forming part of the first program code so as to optimize information processing implemented by a routine or a clone that calls the each of the clones.

6. A program which causes an information processing system, storing first program code and second program code each containing a plurality of routines and third program code containing information indicating routines to be called by a routine of the second program code, to execute the steps of:
generating a clone of each routine indicated by the information of the third program code from among the routines contained in the first program code;
replacing each instruction that calls an other routine of which a clone has been generated, from among instructions calling another routine and being contained in the routines and the clones forming the first program code, with an instruction calling the clone of the other routine; and
rewriting instructions contained in each of the clones forming part of the first program code so as to optimize information processing implemented by a routine or a clone that calls the each of the clones.

7. A method of optimizing program code comprising:
generating a clone of each routine that is going to be called by another routine from among a plurality of routines contained in the program code;
replacing each instruction calling an other routine and being contained in one of the routines and the clones forming the program code with an instruction calling the clone of the other routine; and
rewriting instructions contained in each of the clones forming part of the program code so as to optimize information processing implemented by a routine or a clone that calls the each of the clones.

8. A method of compiling program code comprising:
generating a clone of each routine that is going to be called by another routine from among a plurality of routines contained in the program code;
replacing each instruction calling an other routine and being contained in one of the routines and the clones forming the program code with an instruction calling the clone of the other routine; and
rewriting instructions contained in each of the clones forming part of the program code so as to optimize information processing implemented by a routine or a clone that calls the each of the clones.

9. Program code compiled by:
generating a clone of each routine that is going to be called by another routine from among a plurality of routines contained in the program code;
replacing each instruction calling an other routine and being contained in one of the routines and the clones forming the program code with an instruction calling the clone of the other routine; and
rewriting instructions contained in each of the clones forming part of the program code so as to optimize information processing implemented by a routine or a clone that calls the each of the clones.

10. An information processing system comprising:
a program code storage section that stores program code containing a plurality of routines;
a cloned routine generator that generates a clone of each routine that is going to be called by another routine from among the routines contained in the program code;
a call instruction change section that replaces each instruction calling an other routine and being contained in one of the routines and the clones forming the program code with an instruction calling the clone of the other routine; and
an optimizing section that rewrites instructions contained in each of the clones forming part of the program code so as to optimize information processing implemented by a routine or a clone that calls the each of the clones.
